(19) United States
(12) Patent Application Publication
(10) Pub. No.: US 2021/0053027 A1
(43) Pub. Date: Feb. 25, 2021

(54) Device For Regenerating Activated Carbon

(71) Applicant: Universite Gustave Eiffel, Champs-Sur-Marne (FR)

(72) Inventors: Mehmet Oturan, Villiers Sur Marne (FR); Yoan Pechaud, Clamart (FR); Clément Trellu, Niort (FR); Nihal Oturan, Villiers Sur Marne (FR)

(73) Assignee: Universite Gustave Eiffel, Champs-Sur-Marne (FR)

(21) Appl. No.: 16/980,584

(22) PCT Filed: Mar. 8, 2019
(86) PCT No.: PCT/EP2019/055803

§ 371 Date: Sep. 14, 2020

(30) Foreign Application Priority Data
Mar. 14, 2018 (FR) 1852190

(51) Int. Cl. B01J 20/34; B01J 20/20; B01J 20/28; C02F 1/28; C02F 1/467

(52) U.S. Cl. CPC B01J 20/3416; B01J 20/20; B01J 20/28023; B01J 20/28033; B01J 20/28064; C02F 2001/46147; B01J 20/3441; C02F 1/283; C02F 1/4672; C02F 2201/46185; C02F 2201/4619; B01J 20/2808

(57) ABSTRACT

The invention concerns a device for regenerating activated carbon in the form of porous fibres by electro-Fenton reaction, a method for regenerating activated carbon loaded with organic pollutants using the device of the invention, and the use of a filter consisting of porous fibres of activated carbon, which filter has previously been loaded with organic pollutants by filtration of polluted water or polluted air, as the cathode of an electro-Fenton reaction for regenerating the activated carbon porous fibres loaded with organic pollutants.

### INTRODUCTION

A major challenge for environmental engineering is the development of sustainable water treatment systems with high rates of micropollutant removal. Today, activated carbon (AC) is widely used in water treatment plants as it has proven to be an effective adsorbent for removing organic compounds from water.¹⁻³ This is due to its high surface area, its internal microporosity, and the presence of large amounts of various surface functional groups.⁴

However, it is a simple separation step: the organic pollutants are not degraded after this step. The AC is loaded/saturated with organic pollutants and becomes waste that must be treated. The treatment must lead both to the regeneration/reuse of the AC (in order to improve the sustainability and profitability of the AC process) and to the degradation of the organic pollutants (in order to avoid any environmental contamination).

While the efficiency and adsorption mechanisms of a wide range of organic compounds on various AC materials have already been widely reported in the literature,^{3,5} there remains a need to develop innovative and efficient processes for regenerating spent/saturated/loaded AC.

Thermal regeneration is the most widely used process. The efficiency depends closely on the nature of the adsorbed organic compounds and the nature of the interactions with the AC surface. Thermal regeneration with an inert atmosphere often leads to poor recovery of the initial adsorption capacity due to insufficient desorption of the chemisorbed compounds.⁶ In addition, additional treatment is necessary for the degradation of the desorbed pollutants. Higher removal rates are achieved during thermal treatment under oxidizing conditions but the microporous structure of the AC is then strongly affected by the process, and the adsorption capacity is then reduced during reuse.^{6,7}

Chemical regeneration by oxidation, using for example ozone or the Fenton reaction, limits the oxidation of AC but can also strongly affect its chemical and textural features. In addition, low regeneration efficiency is often observed for microporous AC and chemical regeneration is therefore often applied only to mesoporous or non-porous materials.⁸⁻¹⁰

Recently, the electro-Fenton (EF) process has emerged as a promising solution for regenerating AC. The continuous electro-generation of H₂O₂ from the 2-electron reduction of O₂ at the surface of the AC combined with the supply of a catalytic amount of iron (II) continuously regenerated at the cathode allows the formation of hydroxyl radicals (.OH) (eq 1).¹¹⁻¹³ A platinum (Pt) anode is used as counter-electrode.

Fe²⁺+H₂O₂→Fe³⁺+.OH+OH⁻ (k=63 M⁻¹ s⁻¹) (1)

It has been observed that a wide range of organic pollutants are completely mineralized using the EF process.^{11,13,14} It has also been shown that .OH are capable of oxidizing organic compounds adsorbed on granular AC and thus participate in AC regeneration and pollutant degradation.^{15,36} In addition, Banuelos et al. (2015) observed that cathodic polarization of granular AC during the EF process protects the surface from oxidation and can thus avoid alteration of the material and loss of adsorption capacity.⁷ However, the development, improvement and scale-up of the EF process for regenerating AC is still hindered by technical aspects when using AC as cathode^{7,15}, mainly due to ohmic drops within the granular AC bed and a lack of interconnection at the microstructure level leading to a very heterogeneous potential distribution in the granular AC beds used as cathode.

### INVENTION

Porous fibers have unique features compared with AC in grain or powder form¹⁶. The thin fiber shape and the open pore structure reduce the resistance to intraparticle diffusion of organic compounds from solution to active adsorption sites. This shape also gives the material mechanical and geometrical features suitable for the design of electrochemical reactors. Compared with AC grain beds, porous AC fibers provide a better level of interconnection at the microstructure level and thus reduce ohmic drops as well as dead zones (non-electroactive zones). Thus, AC fiber is an efficient material for adsorption of organic compounds and generation of H₂O₂ during water treatment.^{17,18}

The inventors studied a technology based on electro-Fenton (EF), using AC fiber as cathode and a boron-doped diamond (BDD) coated anode for both regeneration of AC and mineralization of desorbed organic pollutants. The large specific surface area, open pore structure and low resistance to intraparticle diffusion of the porous AC fibers resulted in a high maximum phenol (PH) adsorption capacity (3.7 mmol g⁻¹) and rapid adsorption kinetics.

Spent/saturated porous AC fibers were then used as cathode during the EF process. After 6 h of treatment at 300 mA, 70% of PH was removed from the surface of the porous AC fibers. The inventors surprisingly observed a high efficiency of the process attributed to (i) direct oxidation of the PH adsorbed by hydroxyl radicals generated by the electro-Fenton reaction, (ii) continuous displacement of the adsorption equilibrium due to the oxidation of organic compounds in solution by electro-Fenton reaction and on the surface of the anode by anodic oxidation, (iii) local increase in pH at the cathode leading to repulsive electrostatic interactions, (iv) high electroactive surface area and the good level of interconnection at the microstructure resulting from the use of AC in fiber form, (v) involvement of the BDD anode in the formation of oxidizing species. It is remarkable that 91% of the PH removed from the AC was completely mineralized by the electro-Fenton reaction and anodic oxidation, thus avoiding the adsorption of degradation by-products and the accumulation of toxic compounds such as benzoquinone. The morphological and chemical features of the AC were not affected due to the effect of protection by cathodic polarization. The porous AC fibers were successfully reused for 10 adsorption/regeneration cycles with a regeneration efficiency ranging from 65 to 78%, consistent with the amount of PH removed from the surface of the AC fibers at the end of each regeneration cycle.

Again surprisingly, the inventors successfully combined the EF process with anodic oxidation using BDD as anode. This both promotes the oxidation of adsorbed compounds by mediated oxidation (production of ozone, persulfate, sulfate radical, species that can oxidize compounds on the surface of AC)^{13,19} and increases the mineralization of desorbed pollutants and degradation by-products due to their oxidation by hydroxyl radicals generated on the surface of the BDD anode by water discharge (eq 2 where M is the anode material).¹⁹

M+H₂O→M(.OH)+H⁺+e⁻ (2)

The main disadvantages of conventional regeneration methods are thus avoided by using the EF process according to the invention. Compared with chemical oxidation, a much higher regeneration efficiency of a microporous adsorbent can be achieved. This process according to the invention can also completely mineralize organic molecules, whereas thermal regeneration under inert conditions only leads to the desorption of pollutants. Moreover, the adsorption capacity of porous AC fibers is not affected, unlike chemical oxidation and heat treatment under oxidizing conditions. The choice of using AC in fiber form plays a crucial role on the efficiency of the process because this material has suitable features for both adsorption and regeneration steps.

### FIGURES

FIG. 1: General diagram of the device according to the invention by way of example

FIG. 2: Change in the concentration of phenol adsorbed on activated carbon fabric (Phenol ads), phenol in solution+adsorbed on AC fabric (Total phenol) and total organic carbon in solution+adsorbed on AC fabric (Total TOC) during electro-Fenton regeneration of AC loaded with organic pollutant. The control experiment was performed without power supply (I=0). The concentrations are expressed as a percentage of the total initial concentration ([PH]₀ or TOC₀) in the electrochemical cell, which corresponds to the initial amount of phenol adsorbed on the AC fabric.

FIG. 3: Change in the normalized phenol concentration and the normalized TOC concentration in solution during the regeneration by the electro-Fenton process of the AC fabric loaded with organic pollutants. The error bars represent the standard deviations obtained from experiments performed in triplicate.

FIG. 4: Change in the concentration in solution of the main by-products of phenol degradation (Csol, t) during electro-Fenton regeneration of AC fabric loaded with organic pollutants. The concentration of organic compounds is calculated in mg of carbon per liter and expressed as a percentage of the initial total organic carbon (TOC₀) concentration in the electrochemical cell. The error bars represent the standard deviations obtained from experiments performed in triplicate.

FIG. 5: Change in the regeneration efficiency (RE) as a function of the number of adsorption/regeneration cycles performed. The dotted line corresponds to the rate of elimination of the adsorbed phenol after 6 hours of electro-Fenton regeneration. The error bar on the “cycle 1” point (contained in the data point) represents the standard deviation obtained from an experiment performed in triplicate.

FIG. 6: Scanning electron microscope images of the initial activated carbon fabric (A, E) and after 10 regeneration cycles (B, F). Images C and D focus on the breakage zone of the porous fibers observed in the material after 10 regeneration cycles.

FIG. 7: (A) Ratio between the equilibrium concentrations of benzoquinone (BQ) and hydroquinone (HQ) after adsorption of 0.9 mM HQ on activated carbon (AC) fabric, as a function of the added AC concentration (B) Change in HQ and BQ concentrations during the dynamic adsorption experiment with 0.95 mM HQ and 2 g L⁻¹ AC.

FIG. 8: Change in the hydrogen peroxide concentration in an undivided electrochemical cell as a function of the cathode used (activated carbon felt, activated carbon fabric or conventional carbon felt). Operating conditions: V=125 mL; [Na₂SO₄]=0.1 M; pH=3; I=300 mA; Cathode surface area=140 cm²; Anode: platinum grid. H₂O₂ was analyzed by a spectrophotometric method based on the formation of a yellow complex in the presence of Ti⁴⁺ in acid medium.

FIG. 9: Change in the ratio of phenol concentration in solution ([PH] sol, t) and the initial concentration adsorbed on the activated carbon fabric ([PH] 0=6.4 mM) during electro-Fenton (EF) regeneration (I=300 mA) and during the control experiment without power supply. The error bars represent the standard deviations obtained from experiments performed in triplicate.

FIG. 10: Change in the concentration of phenol adsorbed on activated carbon (AC) felt (Phenol ads), of phenol in solution+adsorbed on AC felt (Total phenol) and of total organic carbon in solution+adsorbed on AC felt (Total TOC) during the electro-Fenton regeneration of the AC loaded with organic pollutants. The concentrations are expressed as a percentage of the total initial concentration ([PH]₀ or TOC₀) in the electrochemical cell, which corresponds to the initial amount of phenol adsorbed on the AC felt.

FIG. 11: Adjustment of the curve of the Raman spectra (initial AC fabric) by combining three Lorentzian-shaped bands at approximately 1 600 cm⁻¹ (G), 1 340 cm⁻¹ (D1) and 1 185 cm⁻¹ (D2) and a Gaussian-shaped band at 1 545 cm⁻¹ (D3). The crosses represent the experimental data.

FIG. 12: Change in the surface ratio of Raman bands D1, D2, D3, D1+D2+D3 (Σ(D)) and G between the initial AC fabric and after one and 10 electro-Fenton regeneration cycles. The error bars represent the standard deviations obtained from analyses performed in triplicate.

FIG. 13: Image of the solutions obtained after mixing for 24 h 250 mL of phenol (11 mM) with 2 g L⁻¹ of regenerated carbon fabric or felt (one cycle). The presence of a large amount of broken porous activated carbon (AC) fibers is observed when using activated carbon felt.

FIG. 14: Change in the normalized TOC concentration in solution during regeneration by the electro-Fenton process of the AC fabric (which has the porous phenol-loaded fibers). Comparison of the use of a platinum anode compared with a BDD anode. The error bars represent the standard deviations obtained from experiments performed in triplicate in the case of the BDD anode.

### SUMMARY OF THE INVENTION

A first subject matter the invention relates to a device for regenerating activated carbon (AC), comprising at least one electrochemical cell comprising:
at least one cathode and at least one anode immersed in an electrolytic solution:
   with porous activated carbon fibers used as electroactive surface at the cathode and allowing the generation of H₂O₂ at their surface during the electro-Fenton reaction, porous fibers on which organic pollutants are absorbed and which served as a filter for organic pollutants;
   the anode comprising a non-active anode material for carrying out anodic oxidation of organic pollutants, the non-active anode material being defined as a material having an oxygen release overvoltage greater than 0.4 V, the non-active anode material being boron-doped diamond (BDD) or a sub-stoichiometric titanium oxide;
an electrolytic solution with:
   an oxygen supply intended to be continuous during the regeneration of the activated carbon in the form of porous fibers;
   an initial supply of Fe²⁺ ions intended to be continuously regenerated during the electro-Fenton reaction;

the device making it possible to create, during the electro-Fenton reaction, oxidizing species at the cathode and the anode, the oxidizing species created at the anode by the anodic oxidation being at least: .OH, O₃, preferably: .OH, O₃, SO₄.⁻ and S₂O₈²⁻

these oxidizing species mineralizing the organic pollutants at the anode, at the cathode and in the electrolyte solution.

In one embodiment, the electroactive surface of the cathode comprises at least 90% of the porous activated carbon fibers allowing the generation of H₂O₂ at their surface.

In another embodiment, the electroactive surface of the cathode comprises only porous activated carbon fibers allowing the generation of H₂O₂ at their surface.

Advantageously, the device is a continuous filtration column reactor of a flow for which the porous fibers are used in situ in the reactor to both filter the pollutants of the flow and be regenerated in situ in the same reactor; several sets of cathode (porous AC fibers) with anode (BDD or sub-stoichiometric titanium oxide) in the flow can be placed in series or in parallel so that the cathode of one set can be regenerated while continuing to filter the flow with the other sets of cathode (porous AC fibers) with anode (BDD or sub-stoichiometric titanium oxide).

A second subject matter the invention relates to a process for regenerating activated carbon loaded with organic pollutants using the device according to the invention.

A third subject matter the invention relates to the use of a filter composed of porous activated carbon fibers as electroactive cathode surface for the electro-Fenton reaction, the porous fibers generating H₂O₂ at their surface during the electro-Fenton reaction, in the device according to one of claims 1 to 14, for regenerating the porous activated carbon fibers loaded with organic pollutants, said filter having been previously loaded with organic pollutants by filtration of polluted water or polluted air.

### DETAILED DESCRIPTION

The invention relates to a device for regenerating activated carbon, comprising at least one electrochemical cell comprising:
at least one cathode and at least one anode immersed in an electrolytic solution:
   with porous activated carbon fibers used as electroactive surface at the cathode and allowing the generation of H₂O₂ at their surface during the electro-Fenton reaction, porous fibers on which organic pollutants are absorbed and which served as a filter for organic pollutants;
   the anode comprising a non-active anode material for carrying out anodic oxidation of organic pollutants, the non-active anode material being defined as a material having an oxygen release overvoltage greater than 0.4 V, the non-active anode material being boron-doped diamond (BDD) or a sub-stoichiometric titanium oxide;
an electrolytic solution with:
   an oxygen supply intended to be continuous during the regeneration of the activated carbon in the form of porous fibers;
   an initial supply of Fe²⁺ ions intended to be continuously regenerated during the electro-Fenton reaction;

the device making it possible to create, during the electro-Fenton reaction, oxidizing species at the cathode and the anode, the oxidizing species created at the anode by the anodic oxidation being at least: .OH, O₃, preferably: .OH, O₃, SO₄.⁻ and S₂O₈²⁻

these oxidizing species mineralizing the organic pollutants at the anode, at the cathode and in the electrolyte solution.

The advantage of the EF reaction is the simultaneous promotion of oxidation of organic compounds both in solution and adsorbed on the AC fabric.

The device according to the invention is particularly advantageous because it makes it possible to reach a degradation kinetics faster than the adsorption kinetics. Thus, the re-adsorption of oxidation by-products on the AC fabric is avoided. The formation of more hydrophilic by-products as well as electrostatic interactions due to the locally high pH at the surface of the AC fabric also help to prevent the adsorption of degradation by-products onto the AC fabric.

The total mineralization of pollutants avoids the accumulation of toxic by-products.

The electrochemical cell has any shape making it possible to delimit a suitable container for the electrodes and the electrolyte solution, for example cylindrical or parallelepipedal.

The electrochemical cell is made of any material making it possible to delimit a suitable container for the electrodes and the electrolyte solution.

It can be open or closed, divided or not. Preferably, it is open and undivided.

Preferably, the activated carbon in the form of porous fibers having served as a filter for organic pollutants is saturated with organic pollutants.

The porous activated carbon fibers loaded with organic pollutants serve as cathode. They come in the form of fabric (woven ordered porous fibers) or felt (non-woven disordered porous fibers), preferably in the form of fabric. The fabric consists of thousands of thin porous fibers with a very high specific surface area.

Advantageously, the cathode consists of activated carbon in the form of porous fibers. They come from or are a filter used previously to filter pollutants from water and/or air.

Preferably, the diameter of the porous fibers is greater than 0.1 micrometer and less than 1 000 micrometers, even more preferable is greater than 1 micrometer and less than 100 micrometers.

The specific surface area (S_{BET}) of the porous fibers is preferably greater than 100 m²·g⁻¹, even more preferably greater than 600 m²·g⁻¹.

Advantageously, the porous fibers have a porosity such that more than 30% of the pore volume of each of the porous fibers is made up of pores smaller than 2 nm, even more preferably more than 80%.

According to one embodiment, the anode consists of a non-active anode material.

According to another embodiment, the anode consists of a substrate at least partially covered with a non-active anode material.

According to the model proposed by Comninellis^{44,45}, the materials used as anode in the electro-oxidation of organic pollutants in aqueous media can be divided into two groups: active and non-active anodes.

In the case of active anodes, the hydroxyl radical (.OH) formed is chemically adsorbed and only slightly available for oxidation of the organic compounds in solution. Rather, these materials promote the O₂ release reaction.

In the case of non-active anodes (such as BDD), the overvoltage for O₂ release is higher (compared with active anodes) and the .OH radicals formed are physically adsorbed. In this case they are more available and react directly with organic compounds.^{44,45,13,19}

The non-active anode material is defined as a material with an oxygen release overvoltage greater than 0.4 V, preferably greater than 0.6 V.

Preferably, the non-active anode material is chosen so that the oxidizing species created are at least: .OH, O₃, preferably .OH, O₃, SO₄.⁻ and S₂O₈²⁻ if sulfate ions are present in the solution.

The .OH ions attack the pollutants adsorbed at the cathode until they are mineralized. Advantageously, the cathodic polarization preserves the surface of the porous activated carbon fibers. The total mineralization of the pollutants avoids the accumulation of toxic by-products.

The non-active anode material is boron-doped diamond (BDD) or a sub-stoichiometric titanium oxide (properties close to BDD in terms of oxygen release overvoltage). Preferably, the non-active anode material is boron-doped diamond (BDD).

The device of the invention may comprise several anodes, in particular several BDD anodes.

By way of example, the device according to the invention may comprise an anode as defined above and two cathodes on either side of the anode as defined above.

According to one embodiment, the anode consists of a substrate at least partially covered with a non-active anode material. Preferably, the anode then consists of a substrate entirely covered with a non-active anode material. Suitable substrates can be cited: Ti, Nb or Si. The thickness of the non-active anode material on the substrate varies from 0.1 to 0.5 mm depending on the overall size of the electrode.

The electrochemical solution has a continuous supply of oxygen for the production of hydrogen peroxide. The oxygen supply is achieved by an inlet of oxygen bubbles or air bubbles into the electrolyte solution, preferably by an inlet of air bubbles into the electrolyte solution. Bubbling helps mix the electrochemical solution.

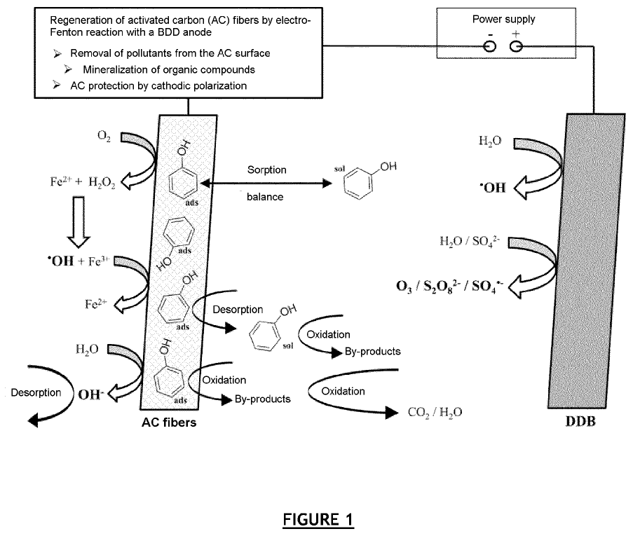

Preferably, the initial supply of Fe²⁺ ions has a catalytic concentration in the electrolyte solution greater than 10⁻⁵ M and less than 10⁻² M, even more preferably comprised between 3*10⁻⁵M and 10⁻³ M. The initial supply of Fe²⁺ ions is advantageously low since these ions are regenerated at the cathode throughout the process (FIG. 1).

The electrodes are separated by a few centimeters, preferably less than 10 cm.

The electrolyte will be chosen appropriately by the person skilled in the art. The presence of salt is necessary to ensure the conductivity of the solution, for example, Na₂SO₄., Na Cl, etc. The conductivity of the solution is greater than 0.01 S m⁻¹.

The electrolyte concentration is between 10⁻³ and 10⁻¹ M.

The electrochemical solution is stirred by magnetic or mechanical stirring, for example.

The pH is adjusted, preferably between 2 and 5, even more preferably between 2.6 and 3.6.

The electrochemical cell is supplied with constant current. The current density is preferably adjusted between 0.1 and 100 mA/cm², preferably between 1 and 30 mA/cm², of activated carbon surface as soon as the spent/saturated AC cathode has been immersed in the electrolyte.

The current density is determined to optimize the production of H₂O₂ and .OH and minimize secondary reactions such as oxygen and hydrogen evolution.

Another subject matter the invention relates to a process for regenerating activated carbon loaded with organic pollutants using the device according to the invention.

Any type of activated carbon filter made from porous activated carbon fibers may be used as cathode of the device according to the invention in order to be regenerated after its use as a filter of organic air and/or water pollutants and may thus be reused again as a filter of organic air and/or water pollutants. This use/regeneration cycle can be repeated several times.

Another subject matter the invention relates to the use of a filter composed of porous activated carbon fibers as electroactive cathode surface for the electro-Fenton reaction, the porous fibers generating H₂O₂ at their surface during the electro-Fenton reaction, in the device according to one of claims 1 to 14, for regenerating the porous activated carbon fibers loaded with organic pollutants, said filter having been previously loaded with organic pollutants by filtration of polluted water or polluted air.

### Examples

The following study aims to evaluate the regeneration efficiency of the AC fiber during the EF process using the BDD anode and the AC fiber loaded with organic pollutant as cathode. Choosing phenol (PH) as the model organic pollutant, the objectives of this study were to evaluate (i) the adsorption capacity and adsorption kinetics of PH and major aromatic oxidation by-products on the porous AC fibers (ii) the removal of PH from the surface of the AC fiber loaded with organic pollutant by the EF process (iii) the release of PH and degradation by-products into the solution and their subsequent mineralization (iv) the adsorption capacity and characteristics of the regenerated material after 1 and 10 adsorption/regeneration cycles.

### Materials and Methods

### 1. Chemicals

All chemicals are reagent grade purchased from Acros Organics (PH and iron (II) sulfate heptahydrate), Sigma Aldrich (hydroquinone (HQ), benzoquinone (BQ), catechol (CAT), methanol, sodium sulfate) or Fluka (sulfuric acid). All solutions are prepared using ultrapure water (resistivity>18.2 MQ cm) from a Millipore Milli-Q system (Molsheim, France).

### 2. Adsorption

Microporous AC fabric (Dacarb, France), prepared from a phenolic resin, was used as adsorption material. N2 adsorption isotherms were performed for the determination of BET surface area, total pore volume and pore size distribution (using the two-dimensional non-local density functional theory method). The main characteristics of the material are presented in Table 1. Some experiments were also performed using AC felt prepared from phenolic resin (Dacarb, France) with different morphological features but similar surface area and microporosity.

TABLE 1
Main features of the activated carbon fabric used in the experiments

| | | | BET specific | pore volume (cm³ g⁻¹) − pore size distribution | | | | |
|---|---|---|---|---|---|---|---|---|
| Weight | Thickness | Average pore | surface area | Microporous | Microporous | Mesoporous | Macroporous | |
| (g m⁻²) | (mm) | size (nm) | (m² g⁻¹) | (<1 nm) | (1-2 nm) | (2-20 nm) | (>20 nm) | Total |
| 90 | 0.5 | 0.82 | 1306 | 65% | 33% | 1.7% | 0.2% | 0.54 |

Before use, the AC was washed several times in deionized water and dried at 70° C. The pH value was set to 3 for all adsorption experiments, the pH value required for the EF regeneration step. Control tests without AC showed that less than 3% PH was lost by volatilization or adsorption to glass after 24 h.

Equilibrium adsorption experiments were performed at room temperature (20° C.) with single compounds in 500 mL glass bottles stirred continuously for 24 h in a rotary shaker set at 20 rpm. For the isothermal experiments, 250 mL of PH (1 mM), BQ (0.5 mM), CAT (0.8 mM) or HQ (0.9 mM) were mixed with various AC concentrations from 0.08 to 1 g L-1. The most widely used models, Langmuir (eq 3) and Freundlich (eq 4), were used to model the experimental data.

$${q}_{e} = \frac{{q}_{m} {K}_{L} {C}_{e}}{1 + {K}_{L} {C}_{e}} \qquad ( 3 )$$

where qₑ is the amount of solute adsorbed per unit weight of AC at equilibrium (mmol g-1), qₘ is the maximum adsorption capacity (mmol g-1), K_{L} is a constant related to the free energy of adsorption (L mmol-1) and Cₑ is the concentration of solute in the stock solution at equilibrium (mmol L-1).

qₑ=K_{F}Cₑ^{1/n} (4)

where K_{F} and n are constants related to adsorption capacity and adsorption intensity, respectively.

The organic pollutant-loaded CAs used for the EF regeneration experiments were obtained by mixing 250 mL PH at 11 mM with 500 mg AC (2 g L-1).

Dynamic adsorption experiments were performed with unique compounds and using a configuration similar to electrochemical regeneration to ensure the same hydrodynamic conditions. The initial concentrations of AC (2 g L-1) and organic compounds ([PH]=1 mM; [HQ]=[CAT]=0.1 mM; [BQ]=0.05 mM) were chosen according to the experimental conditions observed during the EF regeneration step. The data were analyzed using both pseudo-first order (eq 5) and pseudo-second order (eq 6).

ln(qₑ−qₜ)=ln qₑ−k₁t (5)

where qₜ is the amount of solute adsorbed per unit weight of AC at time t and k₁ is the first-order velocity constant.

$$\frac{t}{{q}_{t}} = \frac{1}{{k}_{2} {q}_{e}^{2}} + \frac{t}{{q}_{e}} \qquad ( 6 )$$

where k₂ is the second order velocity constant.
3. EF Regeneration of Porous AC Fibers Loaded with Organic Pollutant

The electrochemical regeneration of porous AC fibers loaded with organic pollutant was carried out in batch mode using an open, cylindrical and undivided electrochemical cell, similar to the configuration previously described by Trellu et al. (2016).²⁰ 500 mg of spent AC (55 cm²×0.5 mm) was used as cathode. The anode consisted of a thin film of BDD deposited on a Nb substrate (24 cm²×0.2 cm, Condias Gmbh, Itzehoe, Germany). For comparison, some experiments were performed with a platinum grid as anode. The electrodes were placed face to face with a space of 3 cm between the anode and the cathode. The AC cathode was fixed in the electrochemical cell using a Teflon grid. Oxygen supply for the production of hydrogen peroxide was provided by continuous air bubbling through sintered glass.

0.05 M Na₂SO₄ (electrolyte) was dissolved in Milli-Q water, the pH was adjusted to 3.0 with H₂SO₄ and 0.1 mM Fe²⁺ (catalyst) was added to the solution.²¹ Continuous stirring was provided by magnetic stirring and air bubbling. The constant current supply was provided by a power supply (HAMEG, model 7042-5, Germany) adjusted to 300 mA as soon as the AC cathode loaded with organic pollutant was immersed in the electrolyte. This corresponds to 5.5 or 12.5 mA cm⁻² as current density considering either the surface of the AC cathode or the surface of the BDD anode, respectively. The current density was determined to optimize the production of H₂O₂ and .OH and to minimize secondary reactions such as oxygen and hydrogen evolution.

### 4. Analytical Methods

Chemical analyses were carried out to monitor the change in the concentration of PH and degradation by-products in solution and adsorbed on the porous AC fibers. Aqueous samples (1 mL) were periodically collected from the solution during treatment, while the analysis of the organic compounds adsorbed on AC required stopping the experiment in order to perform a desorption step. The porous AC fibers used as cathode were immersed in a 90%-10% 1 M NaOH ethanol solution and placed for 30 minutes in an ultrasonic bath. After mixing under magnetic stirring for an additional 30 minutes, an aliquot was collected and analyzed. Different authors have observed that such conditions effectively remove adsorbed organic compounds from the surface of AC.^{22,23} Preliminary experiments showed that more than 97% of the adsorbed PH was desorbed and recovered after repeating this procedure twice. The PH and aromatic by-products were analyzed by reversed-phase HPLC, while carboxylic acids were identified and quantified by ion-exclusion chromatography. Analytical conditions were similar to those of Pimentel et al. (2008).²⁴ The PH mineralization rate was monitored by measurement of total organic carbon (TOC) with a Shimadzu TOC-V analyzer.

### 5. Material Characterization

A scanning electron microscope (Phenom XL, PhenomWorld, The Netherlands) was used to analyze the surface morphology of the AC fabric. Since AC is conductive, no surface treatment was necessary prior to analysis.

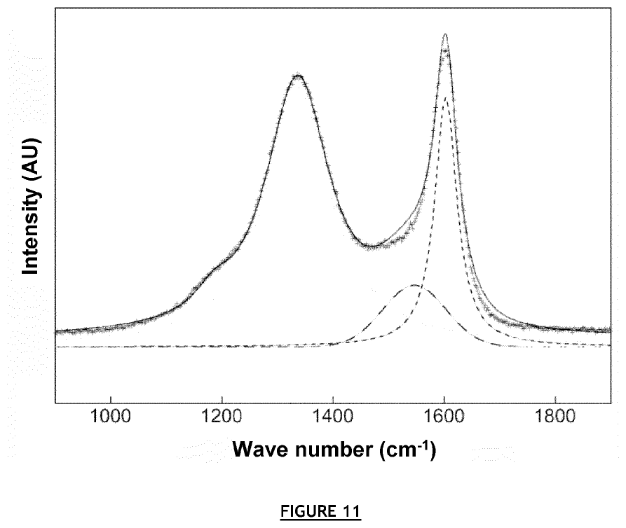

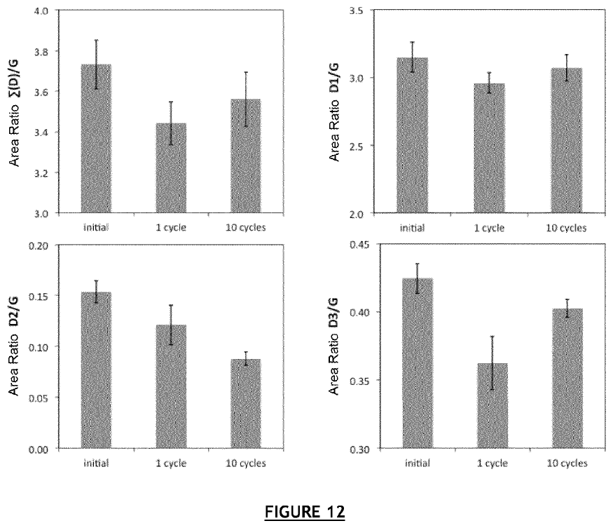

Raman measurements were performed on an INVIA Renishaw spectrometer equipped with a microscope and CCD detector (LGE, France). The details are given below (see FIGS. 11 and 12).

### Raman Analysis

A 532 nm green solid-state laser (Nd: YAG) was used with a maximum power of 50 mW. Acquisitions were performed using a Leica magnification objective (×50) after calibration on a silicon standard. With this configuration, the beam diameter did not exceed 2 microns. The component of Rayleigh diffusion was eliminated by an Edge filter, and the light diffused by Raman was dispersed by a holographic grating with 1 800 lines mm⁻¹. The integration time was set at 2 min. The acquisitions were repeated at 3 different points of the material. The spectral analysis was carried out with the WIRE software.

### Results

1. Sorption of Phenol and Major Aromatic Oxidation by-Products on AC Tissues

The first step of this study consisted in determining the adsorption behavior of PH and the main aromatic oxidation by-products on AC fabric. The PH, BQ and CAT adsorption isotherms are presented in Table 2. As reported in previous studies, a classical L-shaped adsorption isotherm was obtained for all compounds.^{2,25,26} The Langmuir and Freundlich equations are applicable but slightly higher correlation coefficients were obtained using the Langmuir equation for all three compounds, indicating that the assumptions underlying the Langmuir model are appropriate for this material (adsorption of a monolayer of solutes on a homogeneous adsorbent surface with uniform adsorption energies). The maximum PH adsorption capacity (3.73 mmol g⁻¹) is higher than the previous results reported using granular AC (2.32 mmol g⁻¹). This is due to the larger BET surface area (1 326 vs. 929 m² g⁻¹) as well as the microporous structure of the AC fiber since the adsorption energy is improved in the smaller pore sizes. Furthermore, efficient adsorption requires that the average pore size (0.82 nm) be greater than 1.2 times²⁷ or 1.7 times²⁸ the second largest dimension of the adsorbed molecule (for PH 0.42 nm).²⁹ A low steric hindrance effect is therefore expected in this study because this ratio reaches 2.0.²⁷⁻²⁹ Compared with PH, aromatic oxidation by-products (BQ and CAT) showed a much lower adsorption capacity on AC tissues (lower qₘ and K_{F} values). This is consistent with the lower hydrophobicity of hydroxylated by-products, which are less likely to be adsorbed on the carbon surface. Physical adsorption probably plays the most important role for PH adsorption on porous AC fibers, especially π-π interactions.²⁹ However, other factors may be involved in the adsorption mechanisms, including the formation of an electron donor/acceptor complex between the solute and the AC surface), electrostatic interactions (depending on the pH of the solution), molecular size and the effect of the solvent (competitive adsorption of water molecules).^{2,29}

The kinetic study shows that a large amount of PH can be rapidly adsorbed onto the AC fabric. Similar to what has been demonstrated by several previous studies, the determining step in the process of PH adsorption on AC is intraparticle diffusion (linear relationship between qₜ and t^{1/2}).^{29,30}

The resistance to intraparticle diffusion is greatly reduced compared with granular AC due to the open pore structure.²⁹ The AC fabric consists of thousands of thin porous fibers, which greatly increases the external surface area. Much better correlation coefficients were obtained using the pseudo-second order model compared with the pseudo-first order model. Such behavior is often observed for the adsorption of low molecular weight compounds on small adsorbent particles (adsorbent with a large external surface area).³¹ Adsorption processes also obey the pseudo-second order model when the initial solute concentration is sufficiently low.³² Experiments were performed using PH (1 mM), CAT (0.1 mM) and BQ (0.05 mM) concentrations corresponding to the maximum concentrations observed during the regeneration step. Therefore, the kinetic parameters could not be directly compared since pseudo-first order and pseudo-second order kinetic constants are complex functions of the initial solute concentration.³² However, Wu et al. (2009)³¹ showed that the parameter k₂qₑ (eq 6) corresponds to the inverse of the half-life of the adsorption process and is a key parameter for the comparison of adsorption kinetics. Thus, from the observed k₂qₑ values, it can be concluded that adsorption becomes faster in the following order: PH>BQ>CAT. Adsorption kinetics of PH on AC fabric were slower than in a previously reported study²⁹, most likely due to the smaller average pore diameter affecting intraparticle diffusion. Steric hindrance may not affect the final amount of PH adsorbed but still reduce the adsorption kinetics.

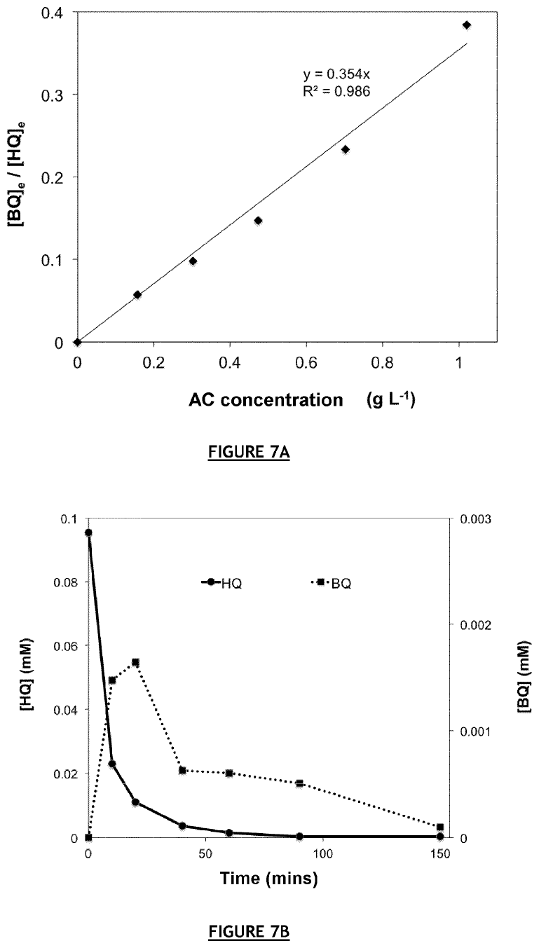

During the adsorption of HQ on AC fabric, the release of BQ into solution was observed simultaneously; subsequently, the adsorption of BQ was also observed (FIG. 7B). This can be explained by the oxidation of HQ by graphite-bound molecular O₂.² As AC fabric concentrations increased in equilibrium experiments, a linear correlation was observed between the ratio [BQ]_{eq}/[HQ]_{eq} and AC concentration (FIG. 7A), indicating that the oxidation of HQ on the surface of AC is governed by a stoichiometric ratio. Moreover, no oxidation of HQ was observed in the absence of AC. This confirms that AC fabric acted as a mediator for the oxidation of HQ to BQ.

TABLE 2
Langmuir and Freundlich parameters of the adsorption isotherms
and pseudo-first and pseudo-second order kinetic constants for
the adsorption of phenol (PH), benzoquinone (BQ) and catechol (CAT) on
AC fabric at 25° C. The kinetic studies were performed with 2 g
L⁻¹of activated carbon fabric and the following initial concentrations:
[PH] = 1.0 mM; [BQ] = 0.05 mM; [CAT] = 0.1 mM.

| | | | PH | BQ | CAT |
|---|---|---|---|---|---|
| Isotherms | Langmuir | R² | 0.994 | 0.995 | 0.997 |
| | | qₘ (mmol g⁻¹) | 3.73 | 1.41 | 1.88 |
| | | K_{L} (L mmol⁻¹) | 19.1 | 44.3 | 29.6 |
| | Freundlich | R² | 0.991 | 0.994 | 0.992 |
| | | n | 3.30 | 3.47 | 4.37 |
| | | K_{F} (mmol g⁻¹ ) | 4.24 | 1.97 | 2.14 |
| | | (L mmol^{-1/n})) | | | |
| Kinetics | Pseudo- | R² | 0.911 | 0.943 | 0.982 |
| | first | qₑ (mmol g⁻¹) | 0.31 | 0.016 | 0.042 |
| | order | k₁ (min⁻¹) | 0.089 | 0.092 | 0.066 |
| | Pseudo- | R² | 1.00 | 0.999 | 0.999 |
| | second | qₑ (mmol g⁻¹) | 0.62 | 0.026 | 0.054 |
| | order | k₂ (g mmol⁻¹ min⁻¹) | 0.78 | 14.0 | 2.65 |
| | | k₂qₑ (min⁻¹) | 0.48 | 0.37 | 0.14 |

2. Phenol Removal from Porous AC Fibers and Mineralization of Organic Compounds During EF Regeneration

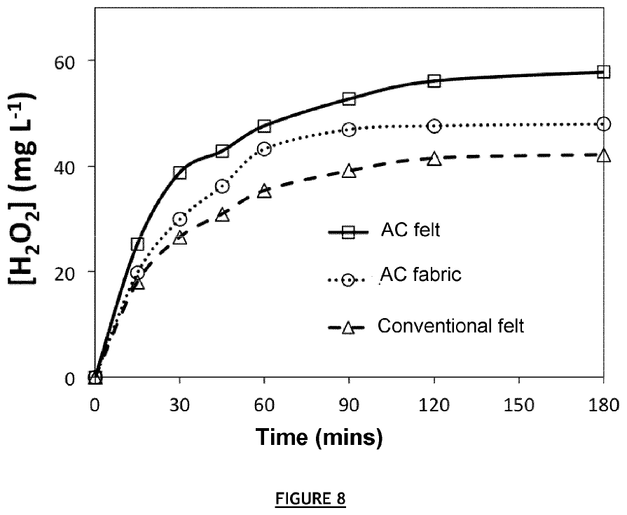

The porous AC fibers are in fabric form. The PH-loaded AC fabric was regenerated using the EF process with a BDD anode and the PH-loaded AC fabric as cathode. Preliminary experiments have shown that the AC fabric is capable of producing more H₂O₂ than a conventional carbon felt usually used in the EF process (FIG. 8). This is probably a beneficial effect of the microporous structure of the AC, which leads to a larger electroactive surface area.

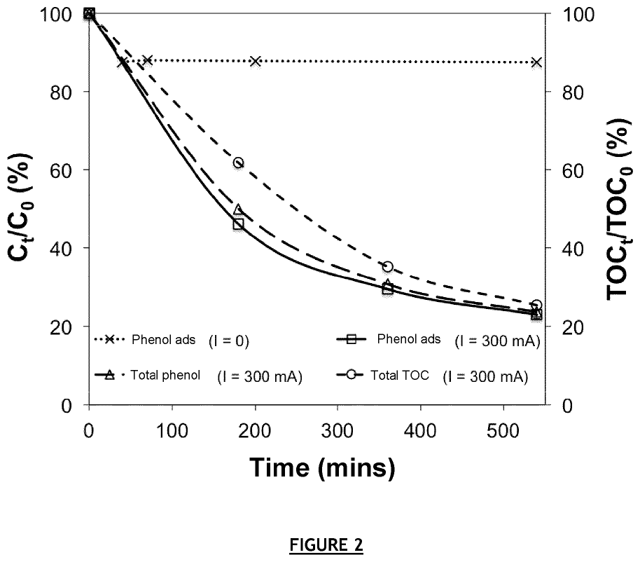

After the adsorption step, the amount of phenol adsorbed on AC was 3.2 mmol g⁻¹; this corresponds to a concentration in the electrochemical cell of 6.4 mM PH ([PH] 0) and a TOC concentration of 461 mg L⁻¹ (TOC₀). After 6 h of treatment at 300 mA, 70% of the initial adsorbed PH was removed from the surface of the AC fabric (FIG. 2). In comparison, only 12.5% of PH was desorbed from the AC fabric during the control experiment without current. This 12.5% was only due to a desorption process that was in accordance with the sorption equilibrium between the solution and the AC.

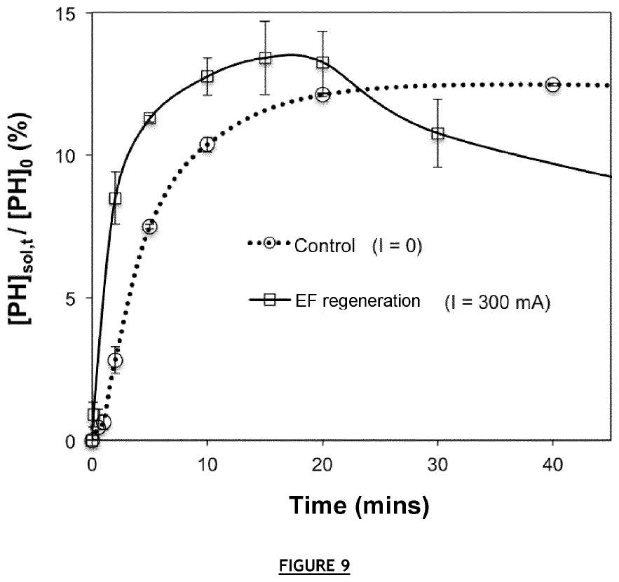

Various phenomena can contribute to the removal of PH from the AC surface. Firstly, a greater increase in the PH concentration in the solution was observed during the first minutes of electro-oxidation at 300 mA, compared with the control experiment without current supply (FIG. 9). This is attributed to a local increase in pH in the vicinity of the cathode due to the reduction of water and the generation of OH⁻. Indeed, this leads to repulsive interactions between the anionic form of the PH and the AC surface. The conventional cathodic regeneration process is based on this mechanism³³. Unfortunately, pH-induced desorption is often not sufficient to achieve a high regeneration efficiency of saturated AC, especially in case of (irreversible) chemical sorption of pollutants.^{34,35} The advantage of the EF process is that it simultaneously promotes the oxidation of organic compounds both in solution and adsorbed on the AC fabric.

The adsorbed organic compounds can react directly with oxidizing species such as —OH from the EF process and electrochemically generated redox reagents (H₂O₂, O₃, persulfate, sulfate radical). Using conventional Fenton oxidation, a very low regeneration efficiency of microporous AC has been reported due to the limited availability of the adsorbed molecules in the micropores to the oxidizing species.⁸ During the EF process, H₂O₂ is generated on the surface of the AC pores, therefore, .OH can be produced in the vicinity of the target pollutants adsorbed on the surface of the AC according to the electrochemically supported Fenton reaction (eq 1). This increases the availability of the adsorbed pollutants for oxidation. Thus, a higher regeneration efficiency of microporous AC can be achieved by EF compared with conventional Fenton oxidation. In addition, the low intraparticle diffusion resistance of the porous AC fibers promotes the diffusion of oxidizing species into the microporosity of the AC, thus improving the availability of the adsorbed compounds to the oxidizing species. In addition, a high rate of PH degradation in solution implies a shift in the sorption equilibrium and the continuous release of PH from the AC fabric to the solution.

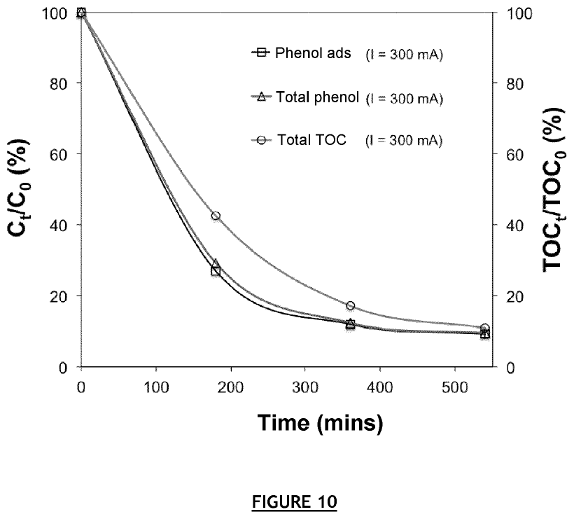

Similar experiments were also performed using porous AC fibers in the form of AC felt instead of AC fabric (FIG. 10). A higher removal rate of adsorbed PH (88% after 9 h) was observed using AC felt during EF regeneration. This could be attributed to a lower intraparticle diffusion resistance, which promotes desorption kinetics and diffusion of oxidizing species into the AC microporosity. However, this material has mechanical properties that are less suitable for water treatment.

Whether using felt or AC fabric, the PH was primarily removed from the cathode for the first 3 hours, then the efficiency of the process decreased significantly. This could be related to the presence of physisorbed and chemisorbed pollutants and the slower removal of the chemisorbed PH. Furthermore, a lower availability (with respect to oxidizing species) of PH molecules adsorbed in the smaller pores of the porous AC fibers could also reduce the efficiency after the first 3 hours of treatment.

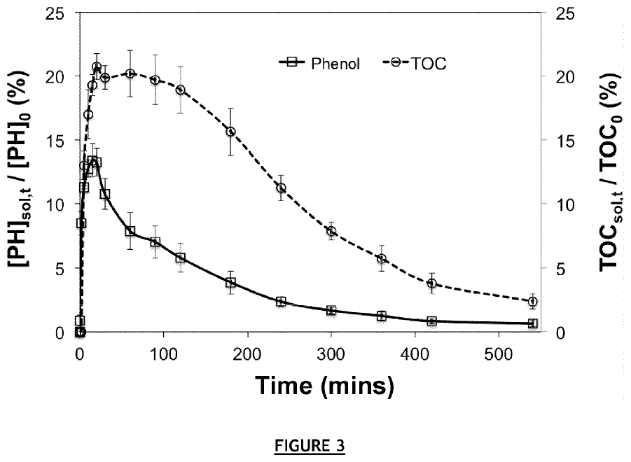

The great advantage of this process is to avoid the accumulation of organic compounds in the solution. Only 6% of the initial adsorbed TOC is found in the solution after 6 h of treatment (FIG. 3). This means that 91% of the 70% PH removed from the AC fabric has been completely mineralized to CO₂ and H₂O. The concentration of PH and TOC in the solution increases rapidly during the first 20 minutes due to the rapid desorption of part of the adsorbed PH. Then, the change in the PH and TOC concentration depends on: (i) the desorption and degradation kinetics of the adsorbed PH on AC, (ii) the degradation kinetics of the PH in solution and the shift of the adsorption equilibrium leading to the desorption of the PH and (iii) the mineralization kinetics of the oxidation by-products in solution. A higher accumulation of TOC was observed in the solution compared with the PH concentration. Indeed, the TOC in the solution comes from both PH desorption and the release of oxidation by-products from the adsorbed and dissolved PH. However, a rapid decrease of TOC in solution was observed due to the high production rate of .OH both in solution (eq 1) and on the surface of the BDD anode (eq 2). In addition, no degradation by-products were detected as adsorbed on the AC fabric during treatment. The process achieves faster degradation kinetics than adsorption kinetics. Thus, re-adsorption of oxidation by-products on the AC fabric is avoided. The formation of more hydrophilic byproducts, the occupation of the adsorption sites by residual PH and water molecules as well as electrostatic interactions due to the locally high pH at the surface of the AC fabric also help prevent the adsorption of degradation byproducts.

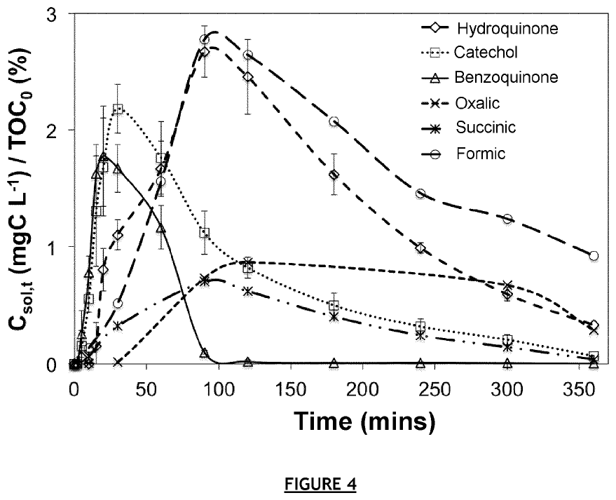

The total mineralization of pollutants avoids the accumulation of toxic by-products such as BQ (FIG. 4). The other aromatic intermediates identified were mainly CAT and HQ.

Resorcinol was detected only in very low amounts since phenol hydroxylation is mainly promoted in the para (HQ) and ortho (CAT) positions.³⁷ CAT quickly reached its maximum concentration at t=30 min (2.2% TOC₀) because its production rate from PH oxidation is highest at the beginning of the experiment and then decreases continuously due to the lower PH concentration. The BQ concentration also peaked rapidly at t=20 min (1.8% TOC₀) and then rapidly decreased below the detection limit at t=120 min. By comparison, the HQ concentration peaked later (t=90 min, 2.8% TOC₀) and decreased much more slowly. Pimentel et al. (2008) observed a similar behavior during PH removal by EF with a conventional carbon cathode.²⁴ As suggested in the literature, this could be explained by taking into account the equilibrium of the redox couple HQ/BQ (E°=0.70 V) and the possible reduction of BQ to HQ.^{37,38} In addition, Mousset et al. (2016) reported that the degradation kinetic constants of the oxidation of BQ to muconic and maleic acids is about an order of magnitude greater than those of the oxidation of HQ to the same degradation by-products.³⁷ The aromatic by-products undergo aromatic ring-opening reactions to form short-chain carboxylic acids.¹¹ Succinic, oxalic, and formic acids were the primary short-chain carboxylic acids detected and reached their maximum concentration at 90, 120, and 90 min of electrolysis, respectively. The change in the concentrations of oxidation by-products in solution depends (i) on the amount generated by PH degradation in solution or adsorbed on the AC fabric and (ii) on the degradation kinetics in solution and at the anode surface. Thus, the concentration of short-chain carboxylic acids decreased more slowly than that of aromatic by-products due to their slower reaction kinetics with .OH.^{37,39}

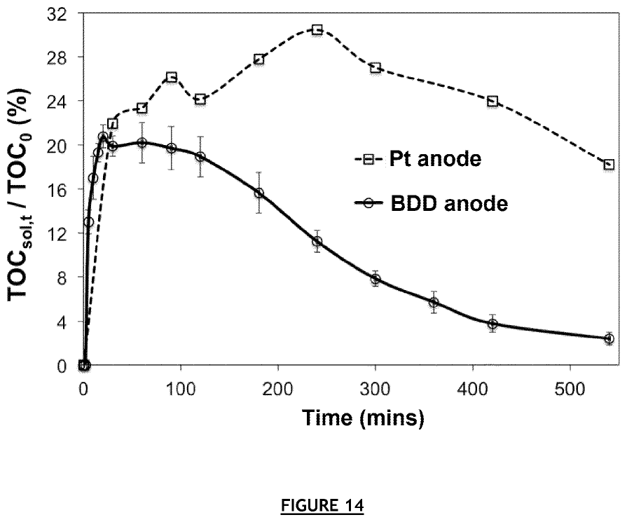

It has been shown that the use of a non-active anode such as BDD plays an important role in the efficiency of the mineralization of desorbed pollutants. By using a platinum anode with porous AC fibers at the cathode, the increase in TOC in solution at the beginning of regeneration is greater, and then the decrease in TOC is much slower than by using a BDD anode (FIG. 14). After 9 h of treatment using a platinum anode, 18% of the initially adsorbed TOC is in the solution, compared with only 2% using a BDD anode. Indeed, platinum is an active anode, with a low oxygen release overvoltage, which does not allow the formation of powerful oxidizing species, unlike the BDD anode for which a synergy with the use of porous AC fibers at the cathode is observed. Moreover, in the case of the use of electropolymerization phenomena of phenolic compounds are observed, leading to passivation and fouling of the platinum anode. Moreover, a sub-stoichiometric titanium oxide anode could also be used instead of BDD with similar efficiency, since both materials are non-active anodes, i.e. they have the feature of having a high O₂ release overvoltage, which allows the formation of powerful oxidizing species (hydroxyl radical, ozone, persulfate, sulfate radical).

### 3. Reuse of Regenerated AC Fiber

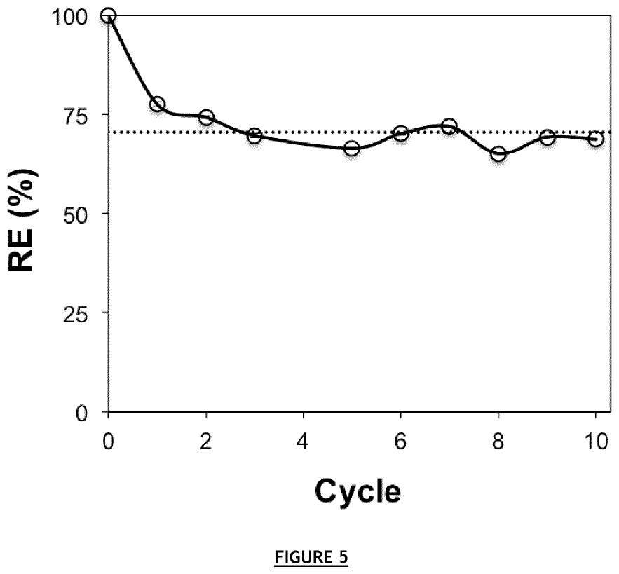

Additional experiments were conducted to evaluate the potential of this technology for the reuse of regenerated AC. Porous AC fibers in the form of AC fabric were chosen as the most promising material, as AC felt showed insufficient mechanical properties for water treatment. Several adsorption cycles followed by EF regeneration were implemented in order to monitor the change in the efficiency of the regeneration process (FIG. 5). In addition, the morphological texture and chemical structure of the AC surface were characterized after one and ten adsorption/regeneration cycles. The optimal regeneration time by EF was set at 6 h because the efficiency of the process decreases between 6 and 9 h of treatment.

The regeneration efficiency (RE) was calculated by comparing the amount of PH that can be adsorbed on the regenerated AC (q_{reg}) and the amount of PH adsorbed on the initial AC (qᵢ) (eq 7)

$$RE ( \% ) = \frac{{q}_{reg}}{{q}_{i}} \times 100 \qquad ( 7 )$$

RE was 78% after one cycle, while only 70% of the adsorbed PH was removed from the AC surface after 6 h of treatment. Thus, taking into account both the residual PH (30% of the initial AC adsorption capacity) and the new PH adsorbed on the AC (78%) after the first regeneration cycle, the adsorption capacity of the regenerated AC is higher than that of the initial material.

Raman analyses were performed to evaluate the change in the chemical composition of AC fabric. The spectra were analyzed using the following deconvolution procedure: a combination of three Lorentzian-shaped bands at about 1 600 cm⁻¹ (G), 1 340 cm⁻¹ (D1) and 1 185 cm⁻¹ (D2) and one band of Gaussian shape at 1 545 cm⁻¹ (D3) was used (an example is given in FIG. 11). These bands correspond to different vibration modes. Overall, the results show that the chemical composition of the AC fabric is not strongly modified after 10 cycles of EF adsorption/regeneration (FIG. 12). However, a slight decrease of 8% in the ratio of the integrated intensity of the sum of the D-bands to the G-band (IΣD/IG) was observed after one regeneration cycle. A greater decrease in the ID2/IG ratio (21%) and ID3/IG ratio (15%) was observed compared with IDl/IG (6%). Bands D1, D2 and D3 are described as characteristic of the edges of the graphene layers, ionic impurities and amorphous carbon, respectively^{40,41}. These results therefore indicate that the higher adsorption capacity of regenerated AC (after 1 cycle) could be attributed to a cleaning effect of the AC surface by the EF process. Some impurities in the virgin AC fabric are removed during the first EF regeneration.

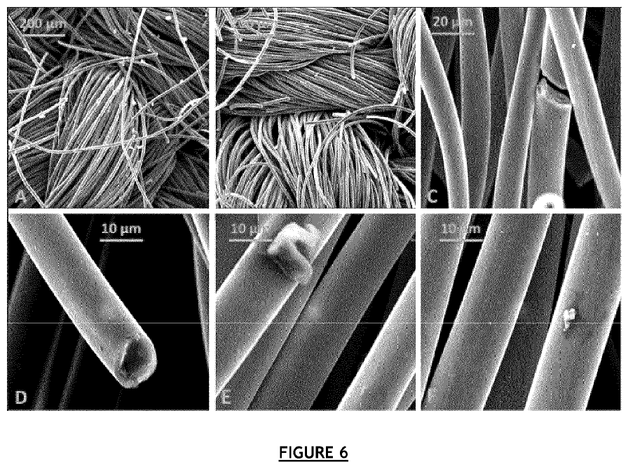

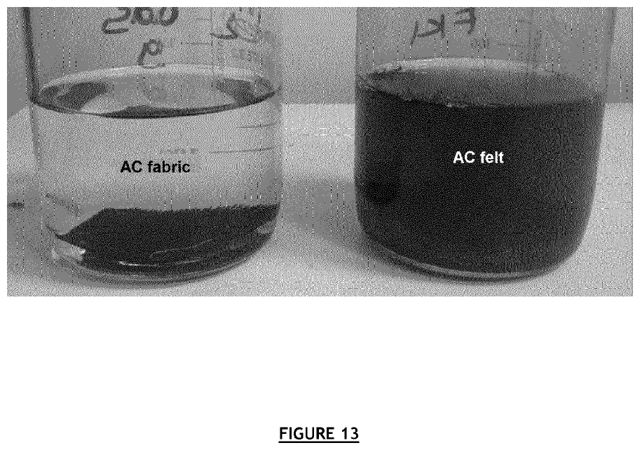

A slight decrease in RE was observed during cycles 2 (74%) and 3 (70%). RE then reached a plateau, with a slight variation between 65% and 72%. The high RE obtained throughout the 10 regeneration cycles demonstrates the relevance of this treatment strategy. The cathodic polarization avoids damaging the AC surface. While the Raman analyses showed a cleaning effect of the AC fabric, comparison of the SEM images shows the absence of any change in the morphological texture of the AC fabric between the initial and regenerated samples (10 cycles) (FIG. 6). The AC fabric consists of thousands of porous fibers with a diameter of about 10 μm closely intertwined. Both the initial and regenerated AC fabric contain broken porous fibers. The morphological texture of the porous fibers is very similar in both samples, even near the point of fiber breakage. Since EF regeneration does not affect the morphological and chemical structure of the AC fabric, the failure of porous fibers appears to result only from mechanical stresses. When using AC fabric, the release of fibers in water was not visible and was not detectable by TOC analysis. On the other hand, using AC felt, the stirring conditions during the adsorption step led to the release of large amounts of small porous fibers into the water (FIG. 13). For this reason, AC fabric seems to be more suitable than AC felt for this type of application^{42, 43}.

### REFERENCES

(1) Gupta, V. K.; Suhas. Application of low-cost adsorbents for dye removal—A review. J. Environ. Manage. 2009, 90 (8), 2313-2342.
(2) Dąbrowski, A.; Podkościelny, P.; Hubicki, Z.; Barczak, M. Adsorption of phenolic compounds by activated carbon—a critical review. Chemosphere 2005, 58 (8), 1049-1070.
(3) Moreno-Castilla, C. Adsorption of organic molecules from aqueous solutions on carbon materials. Carbon 2004, 42 (1), 83-94.
(4) Biniak, S.; Szymanski, G.; Siedlewski, J.; Swiatkowski, A. The characterization of activated carbons with oxygen and nitrogen surface groups. Carbon 1997, 35 (12), 1799-1810.
(5) Kannan, N.; Sundaram, M. M. Kinetics and mechanism of removal of methylene blue by adsorption on various carbons—a comparative study. Dyes Pigments 2001, 51 (1), 25-40.
(6) Alvarez, P. M.; Beltran, F. J.; Gomez-Serrano, V.; Jaramillo, J.; Rodriguez, E. M. Comparison between thermal and ozone regenerations of spent activated carbon exhausted with phenol. Water Res. 2004, 38 (8), 2155-2165.
(7) Banuelos, J. A.; Garcia-Rodriguez, O.; Rodriguez-Valadez, F. J.; Manriquez, J.; Bustos, E.; Rodriguez, A.; Godinez, L. A. Cathodic polarization effect on the electro-Fenton regeneration of activated carbon. J. Appl. Electrochem. 2015, 45 (5), 523-531.
(8) Xiao, Y.; Hill, J. M. Impact of Pore Size on Fenton Oxidation of Methyl Orange Adsorbed on Magnetic Carbon Materials: Trade-Off between Capacity and Regenerability. Environ. Sci. Technol. 2017, 51 (8), 4567-4575.
(9) Brown, N. W.; Roberts, E. P. L.; Chasiotis, A.; Cherdron, T.; Sanghrajka, N. Atrazine removal using adsorption and electrochemical regeneration. Water Res. 2004, 38 (13), 3067-3074.
(10) Hussain, S. N.; Asghar, H. M. A.; Campen, A. K.; Brown, N. W.; Roberts, E. P. L.

Breakdown products formed due to oxidation of adsorbed phenol by electrochemical regeneration of a graphite adsorbent. Electrochimica Acta 2013, 110, 550-559.
(11) Brillas, E.; Sirés, I.; Oturan, M. A. Electro-Fenton process and related electrochemical technologies based on Fenton's reaction chemistry. Chem. Rev. 2009, 109 (12), 6570-6631.
(12) Sirés, I.; Brillas, E.; Oturan, M. A.; Rodrigo, M. A.; Panizza, M. Electrochemical advanced oxidation processes: today and tomorrow. A review. Environ. Sci. Pollut. Res. 2014, 21 (14), 8336-8367.
(13) Martínez-Huitle, C. A.; Rodrigo, M. A.; Sires, I.; Scialdone, O. Single and Coupled Electrochemical Processes and Reactors for the Abatement of Organic Water Pollutants: A Critical Review. Chem. Rev. 2015, 115 (24), 13362-13407.
(14) Oturan, N.; van Hullebusch, E. D.; Zhang, H.; Mazeas, L.; Budzinski, H.; Le Menach, K.; Oturan, M. A. Occurrence and Removal of Organic Micropollutants in Landfill Leachates Treated by Electrochemical Advanced Oxidation Processes. Environ. Sci. Technol. 2015, 49 (20), 12187-12196.
(15) Bañuelos, J. A.; Rodríguez, F. J.; Manríquez Rocha, J.; Bustos, E.; Rodríguez, A.; Cruz, J. C.; Arriaga, L. G.; Godinez, L. A. Novel electro-Fenton approach for regeneration of activated carbon. Environ. Sci. Technol. 2013, 47 (14), 7927-7933.
(16) Suzuki, M. Activated carbon fiber: Fundamentals and applications. Carbon 1994, 32 (4), 577-586.
(17) Brasquet, C.; Roussy, J.; Subrenat, E.; Cloirec, P. L. Adsorption and Selectivity of Activated Carbon Fibers Application to Organics. Environ. Technol. 1996, 17 (11), 1245-1252.
(18) Brasquet, C.; Le Cloirec, P. Adsorption onto activated carbon fibers: Application to water and air treatments. Carbon 1997, 35 (9), 1307-1313.
(19) Panizza, M.; Cerisola, G. Direct and mediated anodic oxidation of organic pollutants. Chem. Rev. 2009, 109 (12), 6541-6569.
(20) Trellu, C.; Ganzenko, O.; Papirio, S.; Pechaud, Y.; Oturan, N.; Huguenot, D.; van Hullebusch, E. D.; Esposito, G.; Oturan, M. A. Combination of anodic oxidation and biological treatment for the removal of phenanthrene and Tween 80 from soil washing solution. Chem. Eng. J. 2016, 306, 588-596.
(21) Özcan, A.; Sahin, Y.; Koparal, A. S.; Oturan, M. A. A comparative study on the efficiency of electro-Fenton process in the removal of propham from water. Appl. Catal. B-Environ. 2009, 89 (3-4), 620-626.
(22) Rodrigues, L. A.; Ribeiro, L. A. de S.; Thim, G. P.; Ferreira, R. R.; Alvarez-Mendez, M. O.; Coutinho, A. dos R. Activated carbon derived from macadamia nut shells: an effective adsorbent for phenol removal. J. Porous Mater. 2013, 20 (4), 619-627.
(23) Hamdaoui, O.; Naffrechoux, E.; Suptil, J.; Fachinger, C. Ultrasonic desorption of p-chlorophenol from granular activated carbon. Chem. Eng. J. 2005, 106 (2), 153-161.
(24) Pimentel, M.; Oturan, N.; Dezotti, M.; Oturan, M. A. Phenol degradation by advanced electrochemical oxidation process electro-Fenton using a carbon felt cathode. Appl. Catal. B-Environ. 2008, 83 (1-2), 140-149.
(25) Hamdaoui, O.; Naffrechoux, E. Modeling of adsorption isotherms of phenol and chlorophenols onto granular activated carbon: Part I. Two-parameter models and equations allowing determination of thermodynamic parameters. J. Hazard. Mater. 2007, 147 (1-2), 381-394.
(26) Giles, C. H.; MacEwan, T. H.; Nakhwa, S. N.; Smith, D. 786. Studies in adsorption. Part XI. A system of classification of solution adsorption isotherms, and its use in diagnosis of adsorption mechanisms and in measurement of specific surface areas of solids. J. Chem. Soc. Resumed 1960, No. 0, 3973-3993.
(27) Pelekani, C.; Snoeyink, V. L. Competitive adsorption between atrazine and methylene blue on activated carbon: the importance of pore size distribution. Carbon 2000, 38 (10), 1423-1436.
(28) Kasaoka, S.; Sakata, Y.; Tanaka, E.; Naitoh, R. Design of molecular-sieve carbon. Studies on the adsorption of various dyes in the liquid phase. Int. Chem. Eng. 1989, 1987 (29), 734-742.
(29) Liu, Q.-S.; Zheng, T.; Wang, P.; Jiang, J.-P.; Li, N. Adsorption isotherm, kinetic and mechanism studies of some substituted phenols on activated carbon fibers. Chem. Eng. J. 2010, 157 (2-3), 348-356.
(30) Moon, H.; Kook Lee, W. Intraparticle diffusion in liquid-phase adsorption of phenols with activated carbon in finite batch adsorber. J. Colloid Interface Sci. 1983, 96 (1), 162-171.
(31) Wu, F.-C.; Tseng, R.-L.; Huang, S.-C.; Juang, R.-S. Characteristics of pseudo-second-order kinetic model for liquid-phase adsorption: A mini-review. Chem. Eng. J. 2009, 151 (1-3), 1-9.
(32) Azizian, S. Kinetic models of sorption: A theoretical analysis. J. Colloid Interface Sci. 2004, 276 (1), 47-52.
(33) Ania, C. O.; Béguin, F. Electrochemical regeneration of activated carbon cloth exhausted with bentazone. Environ. Sci. Technol. 2008, 42 (12), 4500-4506.
(34) Narbaitz, R. M.; McEwen, J. Electrochemical regeneration of field spent GAC from two water treatment plants. Water Res. 2012, 46 (15), 4852-4860.
(35) Zhan, J.; Wang, Y.; Wang, H.; Shen, W.; Pan, X.; Wang, J.; Yu, G. Electro-peroxone regeneration of phenol-saturated activated carbon fiber: The effects of irreversible adsorption and operational parameters. Carbon 2016, 109, 321-330.
(36) Trellu, C.; Péchaud, Y.; Oturan, N.; Mousset, E.; Huguenot, D.; Hullebusch, E. D. van; Esposito, G.; Oturan, M. A. Comparative study on the removal of humic acids from drinking water by anodic oxidation and electro-Fenton processes: Mineralization efficiency and modelling. Appl. Catal. B Environ. 2016, 194, 32-41.
(37) Mousset, E.; Frunzo, L.; Esposito, G.; van Hullebusch, E. D.; Oturan, N.; Oturan, M. A. A complete phenol oxidation pathway obtained during electro-Fenton treatment and validated by a kinetic model study. Appl. Catal. B-Environ. 2016, 180, 189-198.
(38) Bailey, S. I.; Ritchie, I. M.; Hewgill, F. R. The construction and use of potential-pH diagrams in organic oxidation-reduction reactions. J. Chem. Soc. Perkin Trans. 2 1983, No. 5, 645-652.
(39) Oturan, M. A.; Pimentel, M.; Oturan, N.; Sirés, I. Reaction sequence for the mineralization of the short-chain carboxylic acids usually formed upon cleavage of aromatics during electrochemical Fenton treatment. Electrochimica Acta 2008, 54 (2), 173-182.
(40) Sadezky, A.; Muckenhuber, H.; Grothe, H.; Niessner, R.; Pöschl, U. Raman microspectroscopy of soot and related carbonaceous materials: Spectral analysis and structural information. Carbon 2005, 43 (8), 1731-1742.
(41) Cuesta, A.; Dhamelincourt, P.; Laureyns, J.; Martinez-Alonso, A.; Tascón, J. M. D. Raman microprobe studies on carbon materials. Carbon 1994, 32 (8), 1523-1532.
(42) Garcia-Segura, S.; Brillas, E. Mineralization of the recalcitrant oxalic and oxamic acids by electrochemical advanced oxidation processes using a boron-doped diamond anode. Water Res. 2011, 45 (9), 2975-2984.
(43) Radjenovic, J.; Sedlak, D. L. Challenges and Opportunities for Electrochemical Processes as Next-Generation Technologies for the Treatment of Contaminated Water. Environ. Sci. Technol. 2015, 49 (19), 11292-11302.
(44) Comninellis, C. Electrocatalysis in the electrochemical conversion/combustion of organic pollutants for waste water treatment. Electrochim. Acta 1994, 39, 1857.
(45) Comninellis, C., Kapalka, A., Malato, S., Parsons, S. A., Poulios, I., Mantzavinos, D., 2008. Advanced oxidation processes for water treatment: Advances and trends for R&D. J. Chem. Technol. Biotechnol. 83, 769-776. https://doi.org/10.1002/jctb.1873.

1. A device for regenerating activated carbon, comprising at least one electrochemical cell comprising:
at least one cathode and at least one anode immersed in an electrolytic solution:
with porous activated carbon fibers used as electroactive surface at the cathode and allowing the generation of H₂O₂ at their surface during the electro-Fenton reaction, porous fibers on which organic pollutants are adsorbed and which served as a filter for organic pollutants;
the anode comprising a non-active anode material for carrying out anodic oxidation of organic pollutants, the non-active anode material being defined as a material having an oxygen release overvoltage greater than 0.4 V, the non-active anode material being boron-doped diamond (BDD) or a sub-stoichiometric titanium oxide;
an electrolytic solution with:
an oxygen supply intended to be continuous during the regeneration of the activated carbon in the form of porous fibers;
an initial supply of Fe²⁺ ions intended to be continuously regenerated during the electro-Fenton reaction;
the device making it possible to create, during the electro-Fenton reaction, oxidizing species at the cathode and at the anode, the oxidizing species created at the anode by the anodic oxidation being at least: .OH, O₃, preferably: .OH, O₃, SO₄.⁻ and S₂O₈²⁻,
these oxidizing species mineralizing the organic pollutants at the anode, at the cathode and in the electrolyte solution.

2. The device as claimed in claim 1, wherein the electroactive surface of the cathode comprises at least 90% of the porous activated carbon fibers.

3. The device as claimed in claim 1 or 2, wherein the electroactive surface of the cathode comprises only porous activated carbon fibers.

4. The device as claimed in any one of claims 1 to 3, wherein the porous activated carbon fibers are in the form of fabric.

5. The device as claimed in any one of claims 1 to 3, wherein the porous activated carbon fibers are in the form of felt.

6. The device as claimed in any one of claims 1 to 5, wherein the activated carbon in the form of porous fibers having served as a filter for organic pollutants is saturated with organic pollutants.

7. The device as claimed in any one of claims 1 to 6, wherein the initial supply of Fe²⁺ ions has a catalytic concentration in the electrolyte solution greater than 10⁻⁵ M and less than 10⁻² M.

8. The device as claimed in any one of claims 1 to 7, wherein the organic pollutants adsorbed on the porous fibers of the cathode comprise phenol compounds.

9. The device as claimed in any one of claims 1 to 8, wherein the pH is adjusted between 2 and 5, preferably between 2.6 and 3.6.

10. The device as claimed in any one of claims 1 to 9 wherein the diameter of the porous fibers is greater than 0.1 micrometers and less than 1 000 micrometers.

11. The device as claimed in any one of claims 1 to 10, wherein the specific surface area (S_{BET}) of the porous fibers is greater than 600 m2·g-1 and the porous fibers have a porosity such that more than 30% of the pore volume of each of the porous fibers is constituted by pores of size less than 2 nm.

12. The device as claimed in one of claims 1 to 11, wherein the oxygen supply is provided by an inlet of air bubbles into the electrolyte solution.

13. The device as claimed in one of claims 1 to 12, wherein the device is a batch reactor for sequentially treating a volume of water.

14. The device as claimed in one of claims 1 to 12, wherein the device is a continuous flow filtration column reactor for which the porous fibers used in situ in the reactor to filter pollutants from the flow are regenerated in situ in the same reactor.

15. Use of a filter composed of porous activated carbon fibers as electroactive cathode surface for the electro-Fenton reaction, the porous fibers generating H₂O₂ at their surface during the electro-Fenton reaction, in the device as claimed in one of claims 1 to 14, for regenerating the porous activated carbon fibers loaded with organic pollutants, said filter having been previously loaded with organic pollutants by filtration of polluted water or polluted air.

16. Use as claimed in claim 15, said porous activated carbon fibers being in the form of felt or of fabric.
